(19) United States
(12) Patent Application Publication
(10) Pub. No.: US 2026/0359324 A1
(43) Pub. Date: Nov. 12, 2026

(54) SYSTEM AND METHOD FOR GEOSPATIAL DATA CLUSTERING USING CONTEXTUAL SIMILARITY ADJUSTMENTS

(71) Applicant: The Toronto-Dominion Bank, Toronto (CA)

(72) Inventors: Rasa HOSSEINZADEH, Toronto (CA); Keyvan GOLESTAN IRANI, Aurora (CA); Shu Ying CHEN, Markham (CA); Sergei PANAFIDIN, Toronto (CA); Barnali BHATTACHARJEE, Hamilton (CA); Maksims VOLKOVS, Toronto (CA); Dalia FARAG, Pointe-Claire (CA)

(73) Assignee: The Toronto-Dominion Bank, Toronto (CA)

(21) Appl. No.: 19/202,122

(22) Filed: May 8, 2025

(51) Int. Cl. G06F 16/28; G06F 16/29

(52) U.S. Cl. CPC G06F 16/285; G06F 16/29

(57) ABSTRACT

A computer system comprises at least one processor; and a memory coupled to the at least one processor and storing processor-executable instructions which, when executed by the at least one processor, configure the at least one processor to execute a computational assessment of a geospatial dataset to determine a statistical reliability score; compare the statistical reliability score to a predefined reliability threshold to detect insufficient statistical reliability; in response to detecting the insufficient statistical reliability, apply a data clustering algorithm to identify at least one additional geospatial dataset that exhibits at least one contextual similarity with the geospatial dataset; apply a reduction gain factor to adjust the at least one additional geospatial dataset; generate a data cluster by combining the geospatial dataset with the adjusted at least one additional geospatial dataset; and provide the data cluster as input to at least one predictive computational engine that may use artificial intelligence. The clustering algorithm may perform dynamic environment adaptation.

### TECHNICAL FIELD

The present application relates to systems and methods for geospatial data clustering using contextual similarity adjustments.

### BACKGROUND

Predictive computational engines often rely on geospatial datasets. When these geospatial datasets lack sufficient statistical reliability, due to sparse data points, uneven distributions, or geographic variability, predictive models may suffer from underfitting, leading to inaccurate assessment and unreliable predictions.

Conventional approaches in artificial intelligence often discard low-reliability datasets or supplement them with external data, leading to potential overfitting and bias.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is a schematic diagram outlining various components of an artificial intelligence system;

FIG. 4 shows, in flowchart form, an example method for geospatial data clustering using contextual similarity adjustments; and FIG. 5 shows an example graph generated by a graph-based clustering algorithm that represents a particular geographic region and at least one additional geographic region as nodes.

Like reference numerals are used in the drawings to denote like elements and features.

### DETAILED DESCRIPTION OF VARIOUS EMBODIMENTS

Accordingly, in one aspect, there is provided a computer system comprising at least one processor and a memory coupled to the at least one processor and storing processor-executable instructions which, when executed by the at least one processor, configure the at least one processor to execute a computational assessment of a geospatial dataset to determine a statistical reliability score, compare the statistical reliability score to a predefined reliability threshold to detect insufficient statistical reliability, in response to detecting the insufficient statistical reliability, apply a data clustering algorithm to identify at least one additional geospatial dataset that exhibits at least one contextual similarity with the geospatial dataset, apply a reduction gain factor to adjust the at least one additional geospatial dataset, generate a data cluster by combining the geospatial dataset with the adjusted at least one additional geospatial dataset, and provide the data cluster as input to at least one predictive computational engine for execution.

In one or more embodiments, the geospatial dataset is associated with a particular geographic region and the at least one additional geospatial dataset is associated with at least one additional geographic region.

In one or more embodiments, the data clustering algorithm includes a graph-based clustering algorithm that represents the particular geographic region and the at least one additional geographic region as nodes and assigns edge weights reflecting contextual similarity.

In one or more embodiments, edges between nodes represent relationships between geographic regions.

In one or more embodiments, the reduction gain factor is based on a strength of the contextual similarity.

In one or more embodiments, detecting insufficient statistical reliability is based on at least one of a spatial density metric or insufficient data points within the geospatial dataset.

In one or more embodiments, the reduction gain factor is based on the at least one contextual similarity between the geospatial dataset and the at least one additional geospatial dataset.

In one or more embodiments, the geospatial dataset is associated with a particular geographic region and the at least one additional geospatial dataset is associated with at least one additional geographic region, and the contextual similarity includes a distance between the particular geographic region and the at least one additional geographic region.

In one or more embodiments, the data clustering algorithm selects the at least one additional geospatial dataset for sufficient statistical reliability.

In one or more embodiments, the at least one contextual similarity is based on at least one of claim frequency, claim severity, demographics, infrastructure, geospatial proximity, risk zone, or historical data patterns.

In one or more embodiments, the reduction gain factor includes at least one of dynamic scaling, confidence-based adjustment, or geographic decay.

In one or more embodiments, the predictive computational engine applies the data cluster to improve the accuracy of an artificial intelligence engine by mitigating underfitting.

In another aspect, there is provided a computer-implemented method comprising executing a computational assessment of a geospatial dataset to determine a statistical reliability score, comparing the statistical reliability score to a predefined reliability threshold to detect insufficient statistical reliability, in response to detecting the insufficient statistical reliability, applying a data clustering algorithm to identify at least one additional geospatial dataset that exhibits at least one contextual similarity with the geospatial dataset, applying a reduction gain factor to adjust the at least one additional geospatial dataset, generating a data cluster by combining the geospatial dataset with the adjusted at least one additional geospatial dataset, and providing the data cluster as input to at least one predictive computational engine for execution.

In one or more embodiments, the geospatial dataset is associated with a particular geographic region and the at least one additional geospatial dataset is associated with at least one additional geographic region.

In one or more embodiments, the data clustering algorithm includes a graph-based clustering algorithm that represents the particular geographic region and the at least one additional geographic region as nodes and assigns edge weights reflecting contextual similarity.

In one or more embodiments, detecting insufficient statistical reliability is based on at least one of a spatial density metric or insufficient data points within the geospatial dataset.

In one or more embodiments, the reduction gain factor is based on the at least one contextual similarity between the geospatial dataset and the at least one additional geospatial dataset.

In one or more embodiments, the geospatial dataset is associated with a particular geographic region and the at least one additional geospatial dataset is associated with at least one additional geographic region, and the contextual similarity includes a distance between the particular geographic region and the at least one additional geographic region.

In one or more embodiments, the data clustering algorithm selects the at least one additional geospatial dataset for sufficient statistical reliability.

In another aspect, there is provided a non-transitory computer-readable storage medium comprising computer-executable instructions which, when executed, configure at least one processor to execute a computational assessment of a geospatial dataset to determine a statistical reliability score, compare the statistical reliability score to a predefined reliability threshold to detect insufficient statistical reliability, in response to detecting the insufficient statistical reliability, apply a data clustering algorithm to identify at least one additional geospatial dataset that exhibits at least one contextual similarity with the geospatial dataset, apply a reduction gain factor to adjust the at least one additional geospatial dataset, generate a data cluster by combining the geospatial dataset with the adjusted at least one additional geospatial dataset, and provide the data cluster as input to at least one predictive computational engine for execution.

As will be described herein, in one or more embodiments, in response to detecting insufficient statistical reliability within a geospatial dataset, such as for example due to an insufficient number of data points, a supplemental data integration process is applied to incorporate at least one additional geospatial dataset from a neighboring region. The at least one additional geospatial dataset may be selected based on geospatial proximity and contextual relevance to the original geographic region. A reduction gain factor may then be applied to the at least one additional geospatial dataset to adjust its contribution based on geographic distance. In one or more embodiments, the reduction scale factor may decrease the influence of data points as the geographic distance increases, thereby prioritizing data that maintains statistical relevance while minimizing computational overhead.

As will be described herein, in one or more embodiments, a data cluster may be generated by combining the geospatial dataset with the adjusted at least one additional geospatial dataset. In this example, the data cluster may now contain a sufficient number of data points while maintaining computational efficiency. By applying the reduction gain factor, the system reduces the volume of extraneous data processed, thereby optimizing memory usage, minimizing input/output (I/O) operations, and improving the efficiency of downstream computational processes. In one or more embodiments, the data cluster may be utilized for insurance-related calculations or as training data for at least one artificial intelligence (AI) or machine learning (ML) module. By selectively incorporating only relevant data, the system ensures that computational resources are allocated efficiently, reducing processing time and enhancing overall system performance.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

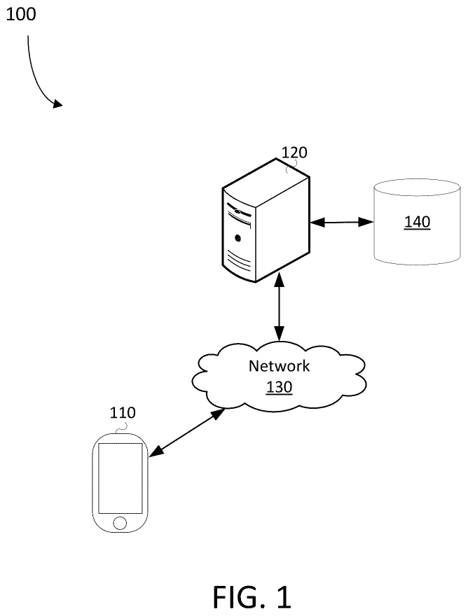

FIG. 1 is a schematic operation diagram illustrating an operating environment of an example embodiment. As shown, the system 100 includes a computing device 110 and a server 120 coupled to one another through a network 130, which may include a public network such as the Internet and/or a private network. The computing device 110 and the server 120 may be in geographically disparate locations. Put differently, the computing device 110 and the server 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may store software instructions that cause the computing device 110 to establish communications with the server 120.

The server 120 is a computer system configured to maintain and manage a database 140. The database 140 stores geospatial datasets, statistical reliability assessments, and contextual data for predictive computational engines. The server 120 may be configured to execute various data processing operations, including geospatial clustering, data augmentation, and predictive modeling.

In one or more embodiments, the server 120 is configured to execute a geospatial data augmentation system that enhances the statistical reliability of datasets by detecting insufficiently reliable geospatial data, identifying additional data from neighbouring regions, applying a reduction gain factor, and generating augmented datasets. These datasets may be used for insurance risk assessments, artificial intelligence or machine-learning, and other predictive computational tasks.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

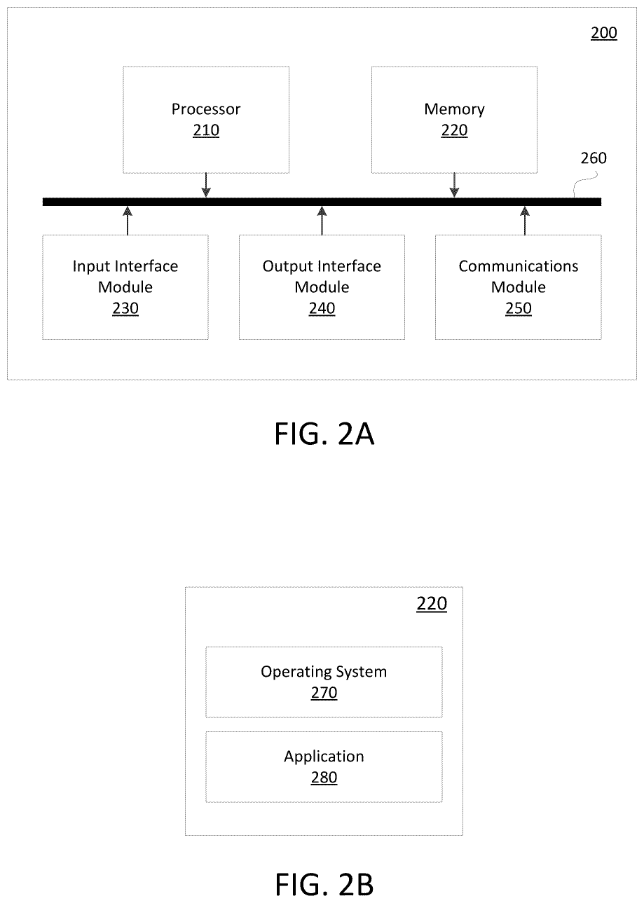

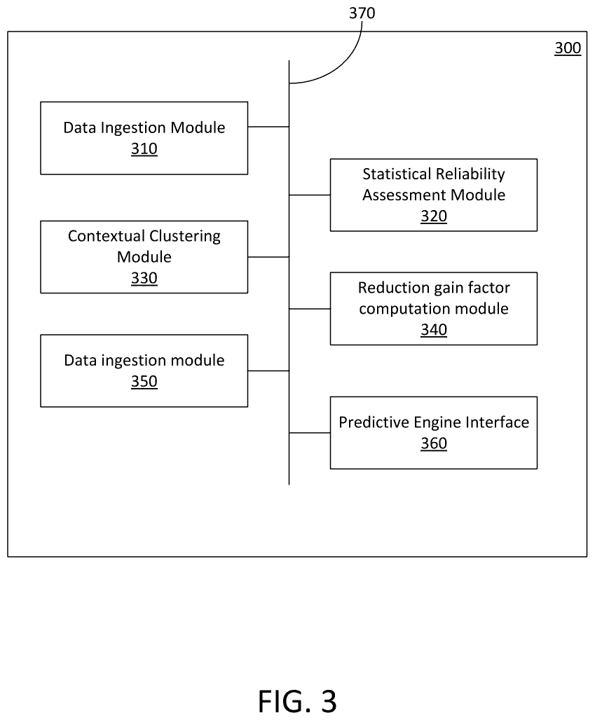

FIG. 2A is a high-level operation diagram of an example computer device 200. In some embodiments, the example computer device 200 may be exemplary of one or more of the computing device 110 and/or the server 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi™, using Bluetooth™ or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux™, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

As mentioned, the server 120 is configured to execute a geospatial data augmentation system that enhances the statistical reliability of geospatial datasets. The system detects insufficient data reliability, identifies additional geospatial datasets, applies reduction gain factors, and generates augmented datasets for use in predictive modeling.

The geospatial data augmentation system utilizes interconnected modules to detect and compensate for insufficient statistical reliability in geospatial datasets by augmenting them with contextually similar data. As will be described, the geospatial data augmentation system enhances predictive accuracy for computational engines.

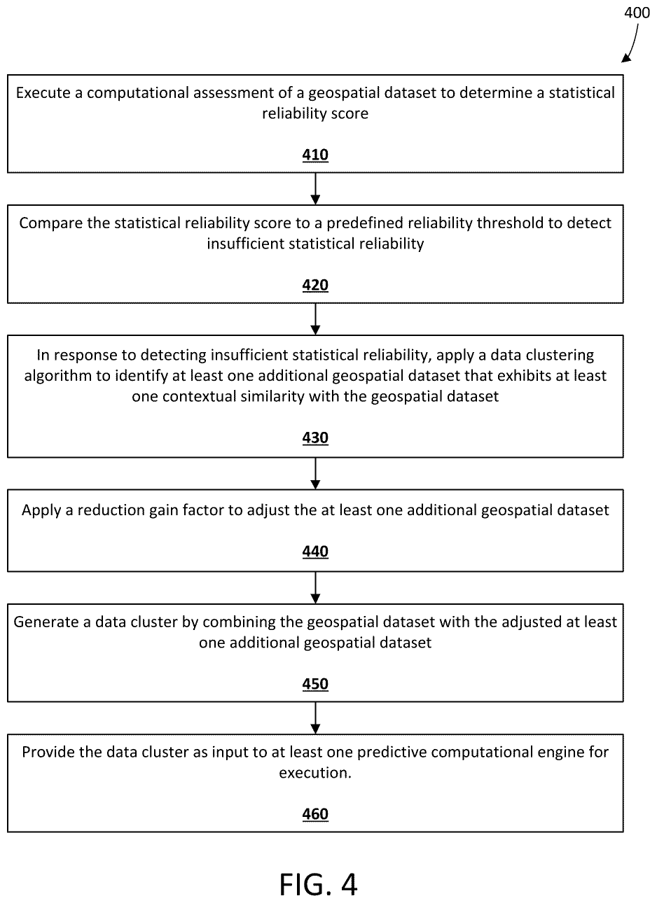

FIG. 3 is an example schematic diagram outlining various components of the geospatial data augmentation system 300. As can be seen, the system 300 includes a data ingestion module 310, a statistical reliability assessment module 320, a contextual clustering module 330, a reduction gain factor computation module 340, a data augmentation module 350, and a predictive engine interface 360. These modules communicate with one another over a processing pipeline 370.

The data ingestion module 310 is configured to collect, normalize, and store geospatial datasets from multiple sources, including insurance claims data, demographic information, climate data, and historical event records. The data ingestion module 310 ensures a continuous flow of up-to-date geospatial datasets for subsequent processing.

In one or more embodiments, the data ingestion module 310 may preprocess raw geospatial datasets by standardizing coordinate reference systems, removing duplicates, and aligning dataset formats. The data ingestion module 310 may also filter incomplete or corrupted data points before storing them in a structured database. The data ingestion module 310 supports both batch and real-time data ingestion pipelines, ensuring the geospatial datasets remain current. The ingested data may be tagged with metadata, including source reliability scores and temporal attributes, for downstream processing.

The statistical reliability assessment module 320 evaluates the completeness, density, and variance of geospatial datasets. As will be described in more detail, the statistical reliability assessment module 320 may generate a reliability score for a geospatial dataset and may determine whether additional data augmentation is required.

In one or more embodiments, the statistical reliability assessment module 320 may execute a computational assessment applying statistical tests such as kernel density estimation (KDE) or z-score normalization to measure data distribution consistency. The statistical reliability score may be determined based on parameters such as spatial density metrics, completeness of data points, and historical variance. In one or more embodiments, the statistical reliability score may be determined based on the number of data points within the geospatial dataset. For example, a minimum threshold may be required for the geospatial dataset to meet the necessary reliability criteria and if the geospatial dataset contains fewer data points then the statistical reliability score may indicate insufficient reliability.

The statistical reliability assessment module 320 may compare the statistical reliability score to a predefined reliability threshold to detect insufficient statistical reliability. If the geospatial dataset does not meet the reliability threshold, the system triggers the contextual clustering module 330 to identify additional geospatial datasets to augment the geospatial dataset.

The contextual clustering module 330 may identify additional geospatial datasets based on at least one contextual similarity such as for example geographic proximity, claim frequency, claim severity, demographics, infrastructure, and risk zone classification.

The contextual clustering module 330 may employ graph-based clustering algorithms to create node-based representations of geographic regions. For example, upon receiving an indication from the statistical reliability assessment module 320 that a geospatial dataset has insufficient statistical reliability, the contextual clustering module 330 may apply a data clustering algorithm to identify at least one additional geospatial dataset that exhibits contextual similarity with the unreliable dataset. The clustering algorithm may include k-means clustering, hierarchical clustering, or graph-based clustering (e.g., spectral clustering), depending on the dataset characteristics. The contextual clustering module 330 may construct a similarity matrix using weighted parameters such as spatial distance, historical claim patterns, and socioeconomic indicators.

In one or more embodiments, in a graph-based clustering approach, nodes may represent geographic regions, and edge weights may reflect contextual similarity based on common attributes such as risk exposure and claim density. Nodes with stronger statistical similarities may be prioritized for data augmentation. The contextual clustering module 330 may ensure that selected additional geospatial datasets meet a minimum statistical reliability threshold before proceeding to the reduction gain factor computation module 340.

The reduction gain factor computation module 340 applies a weighting adjustment to additional geospatial datasets to ensure proportional contribution. As will be described, the reduction gain factor may include a geographic decay function. A geographic decay function may adjust weight based on distance from a target region. The reduction gain factor may include confidence-based scaling. Confidence-based scaling may prioritize datasets with high accuracy. The reduction gain factor may include a dynamic statistical adjustment. The dynamic statistical adjustment may ensure appropriate bias correction.

In one or more embodiments, the reduction gain factor computation module 340 may determine a reduction gain factor based on contextual similarity strength between datasets, prioritizing closer and more statistically relevant datasets while diminishing the influence of outliers. In one or more embodiments, geographic decay may be applied using an inverse distance weighting function or an exponential decay model, where regions farther from the primary dataset contribute progressively less. In one or more embodiments, confidence-based scaling may be used and may adjust dataset weighting based on source reliability scores and historical prediction accuracy. In one or more embodiments, dynamic statistical adjustments may be used to ensure that biases introduced by regional disparities or outlier values are mitigated through normalization techniques such as standard deviation-based correction.

The data augmentation module 350 generates a data cluster by combining a geospatial dataset with one or more adjusted additional geospatial datasets. The data augmentation module 350 may ensure that the data cluster preserves statistical validity while mitigating the risk of underfitting predictive computational engines due to insufficient data.

In one or more embodiments, the data augmentation module 350 may apply an adaptive data fusion technique to integrate the adjusted datasets while maintaining consistency with statistical trends observed in the original dataset. The integration may include feature scaling, outlier smoothing, and covariance-based weighting to prevent distortions in the final data cluster. The data augmentation module 350 may evaluate whether the aggregated dataset meets predefined statistical reliability criteria before passing it to the predictive engine interface 360. If additional augmentation is needed, the data augmentation module 350 may re-trigger the contextual clustering module 330 for further refinement.

The predictive engine interface 360 feeds the data cluster into at least one predictive computational engine. The at least one predictive computational engine may be used for insurance risk assessments, artificial intelligence or machine-learning, and/or other predictive computational tasks.

In one or more embodiments, the predictive engine interface 360 may preprocess the data cluster by structuring it into an appropriate format required by the target predictive computational engine. Feature engineering techniques such as for example one-hot encoding may be used. The predictive engine interface 360 may ensure compatibility with various predictive computational engines by generating both structured data representations and unstructured formats. The predictive engine interface 360 may include an application programming interface (API) layer that allows external predictive computational engines to retrieve the geospatial datasets dynamically.

As will be described, the geospatial data augmentation system 300 ensures robust, contextually relevant data augmentation for predictive computational engines by addressing data sparsity, underfitting risks, and statistical inconsistencies in geospatial datasets.

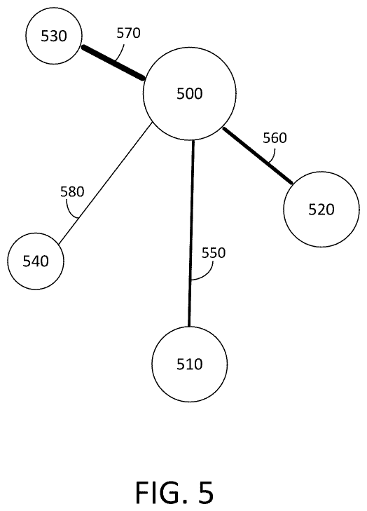

Reference is made to FIG. 4, which illustrates, in flowchart form, a method 400 for geospatial data clustering using contextual similarity adjustments. The method 400 may be implemented by a computing device having suitable processor-executable instructions for causing the computing device to carry out the described operations. The method 400 may be implemented, in whole or in part, by the server 120.

The method 400 includes executing a computational assessment of a geospatial dataset to determine a statistical reliability score (step 410).

In one or more embodiments, the geospatial dataset may be obtained by way of the data ingestion module 310 of the system 300. For example, as mentioned, the data ingestion module 310 is configured to collect, normalize and store geospatial datasets from multiple sources. The geospatial dataset may be for various purposes, including insurance-related calculations, such as risk assessments, claims analysis, and premium pricing, or as training data for artificial intelligence (AI) models aimed at improving prediction accuracy or optimizing decision-making processes.

The geospatial dataset may include a collection of data that is associated with geographic locations which may be represented by coordinates or spatial references. The geospatial dataset may include information about features in a specific geographic area that are relevant for risk modeling, claims prediction, or AI/ML model training.

In one or more embodiments, the geospatial dataset may be associated with a particular geographic region and may be used to assess risk factors, predict trends, or support other insurance-related or AI-based analyses.

In one or more embodiments, the geospatial dataset may include geographic and administrative data associated with postal codes, ZIP codes, cities, counties, and other defined geographic regions. The geospatial dataset may further include land use classifications such as residential, commercial, and industrial zoning, as well as infrastructure data including roads, highways, bridges, and public transport routes. In one or more embodiments, at least a portion of the geographic and infrastructure data may be obtained from government databases, geographic information system (GIS) platforms, or third-party data providers specializing in spatial mapping and urban planning.

In one or more embodiments, the geospatial dataset may store insurance risk data, including information relating to natural disasters such as hurricanes, tornadoes, earthquakes, floods, and wildfires. Additionally, the geospatial dataset may include crime statistics, including theft, burglary, vandalism, and violent crimes, as well as accident-related data such as vehicle collisions, pedestrian incidents, and road hazards. In one or more embodiments, at least a portion of the natural disaster data may be obtained from meteorological agencies, emergency response databases, or environmental monitoring systems. Crime statistics and accident-related data may be sourced from law enforcement agencies, municipal reports, or third-party crime analytics platforms. The geospatial dataset may also store weather pattern data, which may be retrieved from real-time weather monitoring APIs, climate research institutions, or commercial weather forecasting services.

The geospatial dataset may further include insurance-related data such as insurance claims, insurance premiums, policy coverage details, and information relating to insured property, including vehicles, homes, and other assets. The geospatial dataset may store deductible amounts associated with insurance policies, as well as claim frequency and severity data for different geographic regions. In one or more embodiments, at least a portion of the insurance-related data may be obtained from internal databases of insurance providers, third-party insurance aggregators, or industry-wide statistical reporting systems.

Additionally, the geospatial dataset may include demographic and socioeconomic data relating to insured parties, including age, gender, marital status, household size, income levels, employment rates, and education levels. Population density metrics may also be stored in the geospatial dataset to provide insights into regional variations in risk exposure. In one or more embodiments, at least a portion of the demographic and socioeconomic data may be obtained from census reports, government statistical agencies, financial institutions, or third-party consumer data providers.

The geospatial dataset may include property and asset-related data, such as property values, construction materials, roof types, and building age. Fire and flood risk assessments may also be incorporated, including distance to fire stations, proximity to flood zones, and historical damage assessments. In one or more embodiments, at least a portion of the property and asset-related data may be obtained from real estate databases, property assessment records, municipal zoning departments, or satellite imagery analysis services.

Additionally, the geospatial dataset may include historical trends and predictive indicators, such as seasonal variations in insurance claims, fraud indicators, and AI-generated risk classification scores. In one or more embodiments, predictive indicators may be generated by machine learning models trained on historical datasets obtained from a combination of internal insurance data, publicly available records, and third-party predictive analytics services. These data points may be used to enhance predictive modeling, optimize insurance risk assessments, and improve the statistical reliability of geospatial datasets.

In one or more embodiments the geospatial dataset may include geospatial data that is to be provided to a predictive computational engine that may include one or more artificial intelligence (AI) models. In these embodiments, the geospatial dataset may include a broad range of geospatial, environmental, economic, behavioral, and infrastructural data. The geospatial dataset may include transportation and mobility data, such as traffic flow patterns, congestion levels, ride-sharing utilization rates, pedestrian movement analytics, and public transit efficiency metrics. In one or more embodiments, at least a portion of the transportation and mobility data may be obtained from government transportation departments, satellite imagery, GPS tracking systems, and mobility-as-a-service (MaaS) platforms.

The geospatial dataset may further include economic and financial data associated with business activity, property market trends, and consumer spending patterns. Economic indicators such as employment rates, business density, commercial real estate values, and retail foot traffic may be stored to provide insights into regional economic stability and market conditions. In one or more embodiments, at least a portion of the economic and financial data may be obtained from government economic reports, stock market analysis firms, commercial real estate databases, and financial technology services.

The geospatial dataset may include environmental and climate-related data, including air quality indices, pollution levels, soil moisture levels, temperature fluctuations, and carbon footprint metrics. In one or more embodiments, at least a portion of the environmental and climate-related data may be obtained from environmental monitoring agencies, satellite-based remote sensing platforms, and real-time Internet of Things (IOT) sensor networks deployed in urban and rural areas.

The geospatial dataset may also include social and behavioral data, including anonymized location-based social media activity, sentiment analysis trends, and human mobility analytics derived from mobile device signals. Population movement patterns, event attendance data, and tourism activity indicators may also be stored to support AI-driven analysis of human behavior across different geographic regions. In one or more embodiments, at least a portion of the social and behavioral data may be obtained from public social media platforms, anonymized telecommunications network data, and crowd-sourced geospatial intelligence platforms.

Furthermore, the geospatial dataset may include security and cybersecurity intelligence, such as digital infrastructure mapping, cybersecurity incident heatmaps, and risk scores for specific geographic regions. AI-driven threat detection systems may utilize these datasets to predict and mitigate cyber threats affecting critical infrastructure, financial institutions, and government agencies. In one or more embodiments, at least a portion of the cybersecurity intelligence may be obtained from network security monitoring platforms, cybersecurity threat intelligence feeds, and national cybersecurity agencies.

The geospatial dataset may also incorporate healthcare and epidemiological data, including the geographic distribution of healthcare facilities, hospital capacity metrics, disease outbreak patterns, and vaccination coverage statistics. AI/ML models trained on these datasets may be used for public health risk assessments, pandemic modeling, and optimization of healthcare resource allocation. In one or more embodiments, at least a portion of the healthcare and epidemiological data may be obtained from public health agencies, medical research institutions, and global disease surveillance networks.

Additionally, in embodiments where AI/ML models analyze geospatial datasets for urban planning and smart city development, the dataset may include real estate development trends, energy consumption patterns, waste management logistics, and IoT-enabled smart grid analytics. In one or more embodiments, at least a portion of the smart city and urban planning data may be obtained from municipal planning departments, energy utility providers, smart meter networks, and satellite-based urban observation platforms.

In one or more embodiments, the geospatial dataset may be provided to the statistical reliability assessment module 320 for evaluation.

In one or more embodiments, the statistical reliability score may be generated using statistical techniques such as kernel density estimation, standard deviation analysis, or chi-square testing. The computational assessment may also incorporate spatial density metrics to analyze the distribution of data points within a geographic region. The statistical reliability score may reflect the confidence level associated with the geospatial dataset's suitability for predictive modeling.

In one or more embodiments, the statistical reliability score may be determined based on the number of data points within the geospatial dataset. For example, a minimum threshold may be required for the geospatial dataset to meet the necessary reliability criteria and if the geospatial dataset contains fewer data points, the statistical reliability score may indicate insufficient reliability.

The method 400 includes comparing the statistical reliability score to a predefined reliability threshold to detect insufficient statistical reliability (step 420).

In one or more embodiments, detecting insufficient statistical reliability may be based on at least one of a spatial density metric or insufficient data points within the geospatial dataset.

In one or more embodiments, the statistical reliability assessment module 320 may compare the statistical reliability score to a predefined reliability threshold to detect insufficient statistical reliability. If the geospatial dataset does not meet the predefined reliability threshold, the statistical reliability assessment module 320 may trigger the contextual clustering module 330 to identify additional geospatial datasets to augment the geospatial dataset.

In one or more embodiments, the predefined reliability threshold may be established based on historical data reliability benchmarks, industry standards, or adaptive thresholds that vary based on data characteristics. If the statistical reliability score falls below the predefined reliability threshold, the dataset may be deemed insufficient for standalone predictive analysis. In one or more embodiments, the comparison process may be implemented using a rule-based decision framework or a machine learning-based anomaly detection system.

In one or more embodiments, the predefined reliability threshold may consider the number of data points in the geospatial dataset. For example, a dataset may be deemed statistically unreliable if it contains fewer than a predefined number of data points (e.g. 1000), even if other statistical parameters such as spatial density and variance appear sufficient. If the geospatial dataset does not meet the required number of data points, the statistical reliability assessment module 320 may determine that the geospatial dataset does not meet the predefined reliability threshold. If the geospatial dataset does not meet the predefined reliability threshold, the statistical reliability assessment module 320 may trigger the contextual clustering module 330 to identify additional geospatial datasets to augment the geospatial dataset.

In one or more embodiments, insufficient statistical reliability may refer to a geospatial dataset that fails to meet predefined criteria for statistical soundness which may include factors such as completeness, density, and variance of data points, as well as the number of data points present. For example, a geospatial dataset may be deemed to have insufficient statistical reliability if it contains too few data points to draw reliable conclusions or if the data distribution shows significant inconsistencies such as high variance or incomplete coverage in the geographic region. The lack of statistical reliability may lead to issues such as underfitting, where computational predictive engines fail to capture the underlying patterns of the geospatial data due to insufficient information, or overfitting, where computational predictive engines may perform well on a limited geospatial dataset but fail to generalize when applied to larger, more diverse geospatial datasets. To mitigate these risks, the statistical reliability assessment module 320 may trigger data augmentation to ensure the geospatial dataset meets reliability standards and improves the accuracy and generalization of computational predictive engines.

In response to detecting insufficient statistical reliability, the method 400 includes applying a data clustering algorithm to identify at least one additional geospatial dataset that exhibits at least one contextual similarity with the geospatial dataset (step 430).

As mentioned, in response to detecting insufficient statistical reliability, the statistical reliability assessment module 320 may trigger the contextual clustering module 330 to identify additional geospatial datasets to augment the geospatial dataset.

In one or more embodiments, the contextual clustering module 330 may identify the at least one additional geospatial dataset based on at least one contextual similarity. The at least one contextual similarity may include at least one of claim frequency, claim severity, demographics, infrastructure, geospatial proximity, risk zone, or historical data patterns.

Claim frequency may refer to a frequency in which insurance claims are filed within a specific geographic region. At least one additional geospatial dataset that exhibits similar claim frequencies, whether high or low, to the geospatial dataset may be identified and used to augment the geospatial dataset. It will be appreciated that geographic regions with comparable claim frequencies may be deemed contextually similar as they share a pattern of claim occurrence that may maintain consistency and improve predictive accuracy.

Claim severity may refer to an average cost or impact of insurance claims in a particular geographic region. At least one additional geospatial dataset that exhibits similar claim severity, whether high or low, to the geospatial dataset may be identified and used to augment the geospatial dataset. It will be appreciated that geographic regions with similar claim severity may be deemed contextually similar as they share a pattern of claim severity that may maintain consistency and improve predictive accuracy.

Demographics may refer to socioeconomic characteristics of individuals or households within a geographic region. Demographics may include factors such as age, income, gender, marital status, and education levels. Contextual similarity based on demographics may identify at least one geospatial dataset that reflects populations with similar risk profiles or behavior patterns to the geospatial dataset. This may maintain consistency and improve predictive accuracy.

Infrastructure may refer to physical and organizational structures in a region, such as transportation networks, healthcare facilities, and urban development. Regions with similar infrastructure characteristics are likely to experience similar risk factors such as access to emergency services or susceptibility to certain types of natural disasters. Contextual similarity based on infrastructure may identify at least one geospatial dataset that is contextually relevant for data augmentation.

Geospatial proximity may refer to the physical closeness of geographic regions. Geospatial datasets that are geographically close to one another may share common environmental, social, or economic factors that may affect predictive outcomes. Geospatial proximity may be used to identify the at least one additional geospatial dataset and this be associated with at least one additional geographic region that is likely to experience similar risks or trends to the geographic region due to their shared location.

Risk zone may refer to the classification of a geographic region based on its exposure to specific risks such as for example flood zones, earthquake zones, or crime-prone areas. Geospatial datasets from regions with similar risk zone classifications may be considered contextually relevant because they are likely to face comparable threads which impacts risk assessment and predictive accuracy.

Historical data patterns may refer to historical trends and patterns within a geographic region, such as for example past occurrences of natural disasters, accidents, or economic conditions. Geospatial datasets with similar historical data patterns may be considered contextually relevant because they are likely to align with trends that have been observed over time and this may enhance the reliability of predictive computational engines.

In one or more embodiments, the determination of contextual similarity may involve comparing these attributes against predefined thresholds to ensure statistical relevance. For example, the system may consider an additional geospatial dataset sufficiently similar if its claim frequency falls within a predetermined percentage, such as for example 5% or 10%, of the claim frequency of the geospatial dataset. Similarly, geographic regions may be deemed contextually relevant based on proximity constraints, such as being within a specific radius or sharing common risk factors. By applying these similarity thresholds, the contextual clustering module 330 ensures that only relevant and statistically meaningful geospatial datasets are selected, thereby improving the reliability of the aggregated dataset for downstream predictive analysis.

Through use of contextual similarities, the contextual clustering module 330 ensures that the geospatial dataset is augmented with at least one additional geospatial dataset that is not only statistically similar but also contextually relevant and this may improve the overall accuracy and robustness of predictive computational engines.

As mentioned, the geospatial dataset may be associated with a particular geographic region. In one or more embodiments, the at least one additional geospatial dataset that is identified may be associated with at least one additional geographic region. The at least one additional geospatial dataset may be associated with at least one additional geographic region and the contextual similarity may include a distance between the particular geographic region and the at least one additional geographic region.

In one or more embodiments, the data clustering algorithm may include a graph-based clustering algorithm that represents the particular geographic region and the at least one additional geographic region as nodes. The nodes may serve as entities that encapsulate the geospatial data associated with each region. The edges between the nodes may represent relationships or similarities between the geographic regions. The connections between the nodes are determined based on contextual similarities ensuring that only geographic regions with relevant characteristics are grouped together.

In one or more embodiments, the data clustering algorithm may assign edge weights to the edges, with weight values reflecting the degree of contextual similarity between the geographic regions. For example, regions with similar claim frequency, claim severity, or other relevant attributes may have stronger connections, represented by higher edge weights. By leveraging a graph-based approach, the contextual clustering module 330 may ensure that the at least one additional geospatial dataset is identified based on its contextual relevance and consistency with the geospatial dataset. The use of the graph-based clustering algorithm facilitates exploration of relationships between geographic regions, enabling the system to dynamically adjust and refine clusters as more data is incorporated or as conditions evolve.

In one or more embodiments, the data clustering algorithm may additionally or alternatively include k-means clustering. For example, k-means clustering may be applied to a group of geospatial datasets based on contextual similarities such as claim frequency, claim severity, etc. The data clustering algorithm may assign the geospatial datasets to a predefined number of clusters by calculating a distance between feature vectors and the centroids of each cluster. Once the clusters are formed, at least one additional geospatial dataset with contextual similarities to the geospatial dataset are identified within the same cluster.

In one or more embodiments, the data clustering algorithm may additionally or alternatively include hierarchical clustering. For example, hierarchical clustering may include treating each geospatial dataset as an individual cluster and iteratively merging the closest clusters based on a distance metric. As the process continues, a tree-like structure may be formed representing the relationships between geospatial datasets. The at least one additional geospatial dataset may be identified if it falls within a defined proximity or similarity threshold from the geospatial dataset.

In manners described herein, the contextual clustering module 330, specifically through use of the data clustering algorithm, selects the at least one additional geospatial dataset for sufficient statistical reliability. For example, when the geospatial dataset does not have enough data points, such as for example when the geospatial dataset contains fewer than the required number of data points, the contextual clustering module 330 identifies the at least one additional geospatial datasets that can fill in the gaps. The at least one additional geospatial dataset may be identified based on contextual similarities such as for example claim frequency, geospatial proximity, or risk zone classification. The at least one additional geospatial dataset may be analyzed for statistical relevance and consistency with the geospatial dataset to ensure that they contribute to improving the overall reliability of the dataset.

The method 400 includes applying a reduction gain factor to adjust the at least one additional geospatial dataset (step 440).

As mentioned, the reduction gain factor computation module 340 may determine a reduction gain factor based on the strength of contextual similarity between the geospatial dataset and the at least one additional geospatial dataset. In these embodiments, datasets are prioritized that are closer and/or more statistically relevant. The influence of less relevant datasets or outliers is diminished.

In one or more embodiments, the reduction gain factor may be determined based on the strength of the contextual similarity between the geospatial dataset and the at least one additional geospatial dataset.

In one or more embodiments, the reduction gain factor may be based on the at least one contextual similarity between the geospatial dataset and the at least one additional geospatial dataset. For example, the reduction gain factor may incorporate factors such as contextual similarity strength, geographic distance, and source confidence levels. The reduction gain factor may include a geographic decay function, where the contribution of a dataset is reduced as the geographic distance between the original and additional datasets increases. Additionally, confidence-based scaling may be applied to prioritize datasets with higher reliability scores. Furthermore, dynamic statistical adjustments may be made to account for regional variations or inconsistencies in data distributions.

In one or more embodiments, the reduction gain factor may be based on one or more of dynamic scaling, confidence-based adjustment, or geographic decay.

For dynamic scaling, statistical adjustments may be applied to mitigate biases introduced by regional disparities or outlier values. This may involve normalization techniques, such as standard deviation-based correction, to ensure that data from varying regions can be fairly compared.

For confidence-based adjustments, confidence-based scaling may be used to adjust the weighting of datasets based on the reliability of the source dataset and its historical prediction accuracy. Datasets with higher historical accuracy may be weighted more heavily, ensuring that their contributions are prioritized in the clustering process.

In one or more embodiments, the reduction gain factor may include at least one of dynamic scaling, confidence-based adjustment, or geographic decay.

For geographic decay, a geographic decay function may be applied using techniques such as inverse distance weighting or an exponential decay model. For example, regions farther from the geospatial dataset contribute progressively less to the overall data cluster, ensuring that closer regions with higher contextual similarity are prioritized for predictive modeling.

The reduction gain factor is applied to the at least one additional geospatial dataset to generate an adjusted at least one additional geospatial dataset.

The method 400 includes generating a data cluster by combining the geospatial dataset with the adjusted at least one additional geospatial dataset (step 450).

The data augmentation module 350 generates the data cluster by combining the geospatial dataset with the adjusted at least one additional geospatial dataset. The data cluster may include a unified dataset.

In one or more embodiments, the data cluster may be generated by integrating the geospatial dataset with the adjusted at least one additional geospatial dataset. It will be appreciated that the adjustments to the at least one additional geospatial dataset include application of the reduction gain factor performed in step 440. By adjusting the at least one additional geospatial dataset using the reduction gain factor, datasets with weaker contextual relevance contribute proportionally less to the final data cluster, while those with greater relevance have a more significant influence.

To ensure statistical validity during the integration process, feature alignment techniques such as normalization, scaling, and covariance-based adjustments may be applied. These techniques may help standardize the data, ensure compatibility across datasets, and preserve the relationships between features. Normalization standardizes data values, scaling adjustments correct for unit discrepancies, and covariance-based adjustments maintain the correlations between data points.

The data augmentation module 350 may evaluate whether the aggregated dataset meets predefined statistical reliability criteria before passing it to the predictive engine interface 360. If additional augmentation is needed, the data augmentation module 350 may re-trigger the contextual clustering module 330 for further refinement. In this manner, the steps 420 to 450 of the method 400 may be repeated until it is determined that the data cluster meets the predefined statistical reliability criteria.

The method 400 includes providing the data cluster as input to at least one predictive computational engine for execution (step 460).

In one or more embodiments, the predictive engine interface 360 may preprocess the data cluster by structuring it into an appropriate format required by the target predictive computational engine. Feature engineering techniques, such as one-hot encoding, normalization, and scaling, may be applied during preprocessing to enhance the usability of the data cluster. The predictive engine interface 360 may ensure compatibility with various predictive computational engines by generating both structured data representations and unstructured formats. In one or more embodiments, the predictive engine interface 360 may include an application programming interface (API) layer that enables external predictive computational engines to retrieve the geospatial datasets dynamically.

The predictive computational engine may include machine learning models, statistical risk assessment tools, or artificial intelligence-based predictive systems. The data cluster may be used to improve prediction accuracy by mitigating the effects of insufficient data through augmentation. The predictive computational engine may apply various techniques, such as neural networks, decision trees, or gradient boosting models, to generate risk assessments, detect anomalies, or optimize decision-making processes. By augmenting the data with reliable geospatial information, the predictive computational engine can enhance prediction accuracy and robustness. Additionally, by providing a more statistically relevant dataset, the data cluster helps prevent issues such as overfitting, where the predictive computational engine might rely too heavily on irrelevant or noisy data patterns, and underfitting, where the predictive computational engine might fail to capture key patterns or relationships in the data.

In manners described herein, the predictive computational engine may apply the data cluster to improve the accuracy of an artificial intelligence engine by mitigating underfitting. For example, by augmenting a training dataset with additional, contextually relevant geospatial datasets, the predictive computational engine may ensure that the AI/ML model has access to a more comprehensive range of information. This may help the predictive computational engine learn more robust patterns and reduce the risk of underfitting, where the model might otherwise fail to generalize well to new, unseen data. Additionally, the more diverse and statistically reliable data cluster helps the predictive computational engine generate more accurate predictions by capturing nuances and variations within the data that might have been overlooked in a smaller or less reliable dataset.

As mentioned, the data clustering algorithm may include a graph-based clustering algorithm that represents the particular geographic region and the at least one additional geographic region as nodes. An example is shown in FIG. 5. As can be seen, node 500 represents a particular geographic region and nodes 510, 520, 530 and 540 represent additional geographic regions. The size of the node may indicate a size of the geographic region represented thereby. The size may refer to the physical size of the geographic region, the population of the geographic region, or may refer to one or more other attributes such as for example the number of data points available for the geographic region. Edges extend between the node 500 and the nodes 510, 520, 530 and 540. Specifically, edge 550 extends between node 500 and node 510, edge 560 extends between node 500 and node 520, edge 570 extends between node 500 and node 530, and edge 580 extends between node 500 and node 540. Weights are assigned to the edges to represent the degree of contextual similarity between the geographic region represented by the node 500 and the additional geographic regions represented by the nodes 510, 520, 530 and 540. In the example shown, edge 570 has the largest weight and this indicates that the contextual similarity between the geographic region represented by node 500 and the additional geographic region represented by the node 530 is the highest. As such, during the method 400, the at least one additional geospatial dataset that is identified may include the geospatial dataset associated with the additional geographic region represented by the node 530. It will be appreciated that the weighted edges help ensure that the graph-based clustering algorithm accurately captures and prioritizes the most relevant contextual similarities between geographic regions.

An example of geospatial data clustering using contextual similarity adjustments in accordance with the method 400 is now described. In this example, a computational assessment of a geospatial dataset associated with a particular geographic region may be executed to generate a statistical reliability score. The statistical reliability score may be compared to a predefined reliability threshold to detect insufficient statistical reliability. In this example, the insufficient statistical reliability may be due to the geospatial dataset containing too few data points to support reliable analysis. For instance, if a minimum of 1000 data points is required, but the geospatial dataset includes only 600 data points, the system may determine that additional data is needed.

In response to detecting insufficient statistical reliability, the data clustering algorithm may be applied to identify at least one additional geospatial dataset that exhibits at least one contextual similarity with the geospatial dataset. For example, the at least one additional geospatial dataset may be selected based on contextual similarities such as geospatial proximity and demographic characteristics. A reduction gain factor may then be applied to adjust the at least one additional geospatial dataset based on the contextual similarity. In one or more embodiments, the adjustment may be influenced by or based on the geographic distance between the geographic region and the at least one additional geographic region. For example, if the at least one additional geographic region is within a predefined threshold distance, the reduction gain factor may scale its contribution accordingly.

A data cluster may be generated by combining the geospatial dataset with the adjusted at least one additional geospatial dataset. In this example, the data cluster may now contain a sufficient number of data points, exceeding the required threshold of 1000 data points. Once the data cluster meets the statistical reliability criteria, it may be provided as input to at least one predictive computational engine in a manner consistent with the approaches described herein.

In one or more embodiments described herein, in response to detecting insufficient statistical reliability within a geospatial dataset, such as for example due to an insufficient number of data points, a supplemental data integration process is applied to incorporate at least one additional geospatial dataset from a neighboring region. The at least one additional geospatial dataset may be selected based on geospatial proximity and contextual relevance to the original geographic region. A reduction gain factor may then be applied to the at least one additional geospatial dataset to adjust its contribution based on geographic distance. In one or more embodiments, the reduction scale factor may decrease the influence of data points as the geographic distance increases, thereby prioritizing data that maintains statistical relevance while minimizing computational overhead.

A data cluster may be generated by combining the geospatial dataset with the adjusted at least one additional geospatial dataset. In this example, the data cluster may now contain a sufficient number of data points while maintaining computational efficiency. By applying the reduction gain factor, the system reduces the volume of extraneous data processed, thereby optimizing memory usage, minimizing I/O operations, and improving the efficiency of downstream computational processes. In one or more embodiments, the data cluster may be utilized for insurance-related calculations or as training data for at least one AI/ML module. By selectively incorporating only relevant data, the system ensures that computational resources are allocated efficiently, reducing processing time and enhancing overall system performance.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

1. A computer system comprising:
at least one processor; and
a memory coupled to the at least one processor and storing processor-executable instructions which, when executed by the at least one processor, configure the at least one processor to:
execute a computational assessment of a geospatial dataset associated with a particular geographic region to determine a statistical reliability score;
compare the statistical reliability score to a predefined reliability threshold to detect insufficient statistical reliability;
in response to detecting the insufficient statistical reliability, apply a data clustering algorithm to identify at least one additional geospatial dataset associated with at least one additional geographic region and that exhibits at least one contextual similarity with the geospatial dataset, the data clustering algorithm including a graph-based clustering algorithm that represents the particular geographic region and the at least one additional geographic region as nodes and assigns edge weights reflecting contextual similarity;
apply a reduction gain factor to adjust the at least one additional geospatial dataset;
generate a data cluster by combining the geospatial dataset with the adjusted at least one additional geospatial dataset; and
provide the data cluster as input to at least one predictive computational engine for execution.

2. (canceled)

3. (canceled)

4. The computer system of claim 1, wherein edges between nodes represent relationships between geographic regions.

5. The computer system of claim 4, wherein the reduction gain factor is based on a strength of the contextual similarity.

6. The computer system of claim 1, wherein detecting the insufficient statistical reliability is based on at least one of a spatial density metric or insufficient data points within the geospatial dataset.

7. The computer system of claim 1, wherein the reduction gain factor is based on the at least one contextual similarity between the geospatial dataset and the at least one additional geospatial dataset.

8. The computer system of claim 7, wherein the at least one contextual similarity includes a distance between the particular geographic region and the at least one additional geographic region.

9. The computer system of claim 1, wherein the data clustering algorithm selects the at least one additional geospatial dataset for sufficient statistical reliability.

10. The computer system of claim 1, wherein the at least one contextual similarity is based on at least one of claim frequency, claim severity, demographics, infrastructure, geospatial proximity, risk zone, or historical data patterns.

11. The computer system of claim 1, wherein the reduction gain factor includes at least one of dynamic scaling, confidence-based adjustment, or geographic decay.

12. The computer system of claim 1, wherein the predictive computational engine applies the data cluster to improve accuracy of an artificial intelligence engine by mitigating underfitting.

13. A computer-implemented method comprising:
executing a computational assessment of a geospatial dataset associated with a particular geographic region to determine a statistical reliability score;
comparing the statistical reliability score to a predefined reliability threshold to detect insufficient statistical reliability;
in response to detecting the insufficient statistical reliability, applying a data clustering algorithm to identify at least one additional geospatial dataset associated with at least one additional geographic region and that exhibits at least one contextual similarity with the geospatial dataset, the data clustering algorithm including a graph-based clustering algorithm that represents the particular geographic region and the at least one additional geographic region as nodes and assigns edge weights reflecting contextual similarity;
applying a reduction gain factor to adjust the at least one additional geospatial dataset;
generating a data cluster by combining the geospatial dataset with the adjusted at least one additional geospatial dataset; and
providing the data cluster as input to at least one predictive computational engine for execution.

14. (canceled)

15. (canceled)

16. The computer-implemented method of claim 13, wherein detecting the insufficient statistical reliability is based on at least one of a spatial density metric or insufficient data points within the geospatial dataset.

17. The computer-implemented method of claim 13, wherein the reduction gain factor is based on the at least one contextual similarity between the geospatial dataset and the at least one additional geospatial dataset.

18. The computer-implemented method of claim 17, wherein the at least one contextual similarity includes a distance between the particular geographic region and the at least one additional geographic region.

19. The computer-implemented method of claim 13, wherein the data clustering algorithm selects the at least one additional geospatial dataset for sufficient statistical reliability.

20. A non-transitory computer readable storage medium comprising computer-executable instructions which, when executed, configure at least one processor to:
execute a computational assessment of a geospatial dataset associated with a particular geographic region to determine a statistical reliability score;
compare the statistical reliability score to a predefined reliability threshold to detect insufficient statistical reliability;
in response to detecting the insufficient statistical reliability, apply a data clustering algorithm to identify at least one additional geospatial dataset associated with at least one additional geographic region and that exhibits at least one contextual similarity with the geospatial dataset, the data clustering algorithm including a graph-based clustering algorithm that represents the particular geographic region and the at least one additional geographic region as nodes and assigns edge weights reflecting contextual similarity;
apply a reduction gain factor to adjust the at least one additional geospatial dataset;
generate a data cluster by combining the geospatial dataset with the at least one adjusted additional geospatial dataset; and
provide the data cluster as input to at least one predictive computational engine for execution.

21. The computer system of claim 1, wherein the graph-based clustering algorithm performs dynamic environment adaptation by dynamically adjusting the data cluster as additional geospatial data is incorporated.

22. The computer system of claim 21, wherein the graph-based clustering algorithm dynamically refines the cluster of geographic regions as conditions associated with the geographic regions evolve.

23. The computer system of claim 1, wherein applying the reduction gain factor comprises applying a geographic decay function that progressively reduces a contribution of the at least one additional geospatial dataset as a geographic distance from the particular geographic region increases.

24. The computer system of claim 1, wherein generating the data cluster comprises reapplying the data clustering algorithm when the data cluster does not satisfy predefined statistical reliability criteria.
